(19) United States
(12) Patent Application Publication
(10) Pub. No.: US 2012/0147014 A1
(43) Pub. Date: Jun. 14, 2012

(54) METHOD FOR EXTRACTING PERSONAL STYLES AND ITS APPLICATION TO MOTION SYNTHESIS AND RECOGNITION

(76) Inventor: Chao-Hua Lee, Taipei City (TW)

(21) Appl. No.: 13/290,118

(22) Filed: Nov. 6, 2011

Related U.S. Application Data
(60) Provisional application No. 61/420,835, filed on Dec. 8, 2010.

(51) Int. Cl. G06T 13/00

(52) U.S. Cl. 345/474

(57) ABSTRACT

Disclosed is a method for automatically extracting personal styles from captured motion data. The inventive method employs wavelet analysis to extract the captured motion vector of different actors into wavelet coefficients, and thus forms a feature vector by optimization selection, which is used later for identification purposes. When the inventive method is applied to process animation frames, the performance can be evaluated by grouping and classification matrix without any correlation with the type of the motion. Also, even if the type of the motion is not stored in the database in advance, the motions of the actor can still be recognized by a learning module regardless of the type of the motions.

### CROSS REFERENCE TO RELATED APPLICATIONS

This application claims the benefit of priority of U.S. Provisional Application Ser. No. 61/420,835 filed Dec. 8, 2010, incorporated herein in its entirety by reference.

### BACKGROUND OF THE INVENTION

1. Field of the Invention

This application relates to motion capture, and more particularly to a method for extracting personal styles by way of motion capture and its application to motion synthesis and recognition.

2. Description of the Prior Art

In recent years, computer animation is by far the most popular application in the computer engineering industry. The application of computer animation has been widely employed in the field of entertainments, advertisements, scientific simulations, educational trainings, games, and interactive tutorials. The avatars who are the virtual persons appearing in the commercial films, advertisements, and games are produced by using a motion capture appliance to record the motion data of real persons and using the motion synthesis technique with the aid of computer animation technique to automatically produce the video file. Thus, the avatars can act in a variety of lifelike movements.

The trend in the application of computer animation technique has been significantly flourished. Nonetheless, the most time-saving and practical means for producing animation is the motion capture system. The motion capture system was used for the medical rehabilitation in early days. With the advent of the computer animation technique, the motion capture technique has become a novel resolution for producing high-quality computer animation. The motion capture technique is mainly attained by capturing the displacements of real persons by way of the tracking points attached on the real persons and calculating the movement by way of data conversion, and thereby applying the movement to the avatars. The procedure for motion capture method includes the steps of: (1) rehearsing the proceedings of motion capture and planning the motion editing and application tools for the coming proceedings of motion capture; (2) proceeding with motion capture; (3) arranging the motion capture data; (4) editing the motion capture data; (5) applying the motion capture data to avatars.

Nevertheless, the cost of the motion capture system is prohibitive and the procurement of the motion capture system is difficult. Moreover, the motion data still need to be edited with time and effort in order to comply with the desired real motion after the motions have been recorded. Hence, the contemporary motion capture system can not be used prevalently and massively. Currently, only some prohibitively expensive animation software and a few experimental software systems developed by researchers provide a practical motion synthesis function. Most of the computer animation software only provide a simple animation function to animate key frames. Thus, it is a major task to take advantage of the motion capture data of the motion capture system to synthesize the existing motions in order to produce new motions.

The so-called motion synthesis is a technique that can automatically produce animated characters visually resembling the real motions. During the design stage of the conventional computer animation, the animator has to preset each key frame carefully as the motions of the animated characters are being embarked. As a result, a series of sequential frames that do not disobey the physical laws can be produced. Nonetheless, this procedure requires the animator to try and fix the settings of each key frame continuously in order to result in natural key frames.

When the degree of freedom is increased, the settings of the key frames will be a sophisticated task. Hence, it is possible to aid the animator with motion synthesis techniques to produce animated characters that are visually compliant with the physical laws. In practical applications, however, the contemporary motion synthesis techniques are capable of simulating motion characters of human motions by synthesizing the motion data, and the motion characters generally contain a variety of personal styles with a plethora of personal styles. Nonetheless, the contemporary extracting method can not extract the personal styles from integrated motion characters. For example, when the principal components analysis (PCA) method is applied to extract the motion characters, the personal styles can be extracted from the motion characters. However, the personal styles that can be extracted from the motion characters are limited to the same motion category. Other extracting methods, including the independent components analysis (ICA) or hidden Markov models (HMMs), are incapable of efficiently extracting personal styles with personalized characteristics from existing vector data.

In contrast to the motion synthesis, the personalized motion characters are more competent to represent specific personal motion patterns or further highlight the features of the personal styles of a persona. Under ideal circumstances, when the motions of some characters are able to be represented with high tensor, it is indicative of whether the extracted parts are personal vectors, motion vectors, or joint angle vectors. Unknown motions or unknown persons can be recognized by similar corresponding vectors. However, the prior art cannot model style when associated motion data are not contained in the database.

### SUMMARY OF THE INVENTION

An object of the disclosure is to provide a method for automatically extracting personal styles from captured motion data. The inventive method employs the wavelet analysis to extract the captured motion vectors into wavelet coefficient vectors, and form feature vectors representing individual style by an optimization process, which are later used for generating stylized motion even if the individual style is not associated with the motion in the database, regardless of the category of the motion.

Another object of the disclosure is to provide a method for extracting and using personal styles by way of motion capture that includes generating a plurality of signals each corresponding to a channel corresponding to a different base movement of a skeletal configuration; separating each generated signal into wavelets, each wavelet having a corresponding coefficient to model a detail of the corresponding base movement; optimizing each generated signal by removing a number of coefficients such that a total error from the plurality of signals introduced by removal of the number of coefficients is less than or equal to a predefined global error value; generating a feature vector representing a personal style according to an energy level of the removed coefficients; and applying the feature vector to a selected base movement to generate a stylized movement.

Another object of the disclosure is to provide a method for extracting and identifying personal styles by way of motion capture that may include generating a plurality of signals each corresponding to a channel corresponding to a same base movement of a plurality of actors; filtering the plurality of signals into a smoothed signal representing the base movement; separating the smoothed signal into wavelets, each wavelet having a corresponding coefficient to model a detail of the base movement; optimizing the smoothed signal by removing a number of coefficients such that a total error introduced by removal of the number of coefficients is less than or equal to a predefined global error value; and generating a feature vector identifying a personal style according to an energy level of the removed coefficients.

Another object of the disclosure is to provide a non-transitory computer readable medium that may comprise computer code that separates a smoothed signal representing a base movement into wavelets, each wavelet having a corresponding coefficient to model a detail of the base movement; computer code which optimizes the smoothed signal by removing at least one coefficient such that a total error introduced by removal of the at least one coefficient is less than or equal to a predefined global error value; and computer code which generates a feature vector identifying a personal style according to an energy level of the removed coefficients.

Another object of the disclosure is to provide a motion recognition method which may include providing a motion capture database having a multiplicity of motion vectors captured from a multiplicity of motions performed by a multiplicity of actors; extracting the motion vectors to allow each motion vector to be partitioned into a base motion vector corresponding to one of the motions and a personal style vector corresponding to one of the motions; extracting an unknown motion vector that is not captured in the motion capture database to obtain a corresponding base motion vector and a corresponding personal style vector; and comparing the corresponding base motion vector and the corresponding personal style vector with the base motion vector and the personal style vector extracted from the motion capture database, thereby recognizing an actor of the unknown motion vector or recognizing a motion of the unknown motion vector.

Another object of the disclosure is to provide a motion capture system that may include at least one video source providing data for a recorded motion; a processor configured to generate a feature vector comprising a difference between energies of respective coefficients indicating detail for wavelets of a smoothed wave corresponding to a stored base motion and respective coefficients indicating detail for wavelets of the provided data for the recorded motion; and a memory storing the motion vector and the feature vector.

Another object of the disclosure is to provide a method for identifying personal styles by way of motion capture that may include separating a smoothed signal representing a reference base movement into wavelets, each wavelet having a corresponding coefficient to model a detail of the base movement; optimizing the smoothed signal by removing at least one coefficient such that a total error introduced by removal of the at least one coefficient is less than or equal to a predefined global error value; determining the wavelet coefficients of a captured movement; and generating a feature vector identifying a personal style according to an energy level of wavelet coefficients in the captured movement corresponding to the removed at least one coefficients in the base motion.

Another object of the disclosure is to provide a method for synthesizing personal style motions that may include providing a motion capture database having a multiplicity of motion vectors captured from a multiplicity of motions performed by a multiplicity of actors; extracting the motion vectors to allow each motion vector to be partitioned into a base motion vector corresponding to one of the motions and a personal style vector corresponding to one of the motions; and synthesizing the base motion vector and the personal style vector to obtain a specific motion vector that is not captured in the motion capture database.

Another object of the disclosure is to provide a method for synthesizing person style motions using motion capture that may include capturing a first motion of a first actor; capturing a second motion different from the first motion by a second actor different than the first actor; generating a set of wavelet coefficients representing details of the first and second motions for each of the first and second motions; dividing the set of wavelet coefficients for the first motion into subsets, with a first subset representing the base first motion and a second subset representing personal style of the first actor; dividing the set of wavelet coefficients for the second motion into subsets, with a third subset representing the base second motion and a fourth subset representing personal style of the second actor; and combining the first subset with the fourth subset to generate a new motion having the first motion performed having the personal style of the second actor.

Another object of the disclosure is to provide a method for extracting personal styles from captured motion data that may include providing a motion capture database having a multiplicity of motion vectors captured from a multiplicity of motions performed by a multiplicity of actors; and extracting the motion vectors to allow each motion vector to be partitioned into a base motion vector corresponding to one of the motions and a personal style vector corresponding to one of the motions.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a flow chart depicting a process for extracting personal styles from a motion capture database according to an embodiment of the invention;

FIG. 2 shows the characteristic chart depicting the relationship of the rotation angle of the left hip joint when different actors are walking through the use multi-resolution wavelet coefficient analysis;

FIG. 3 is a diagrammatic view depicting the application of an embodiment of invention is employed in motion synthesis; and

FIG. 4 is a simple block diagram of a motion capture system according to an embodiment of the invention.

### DETAILED DESCRIPTION

Embodiments illustrating the features and advantages of the invention will be disclosed in following paragraphs. It is to be realized that the example descriptions provided herein are allowed to have various modification in different respects, all of which are without departing from the scope of the present invention, and the description and the drawings are to be taken as illustrative in nature, but not to be taken as limitations of the invention.

Disclosed is a method for automatically extracting personal styles from motion capture data, as are a method for motion synthesis of personal styles, and a method for motion recognition. The inventive method for automatically extracting personal styles from motion capture data is achieved by extracting motions having personal styles from the motion capture database. The motion extraction is made by extracting the captured motion vector of different actors into a multi-resolution wavelet coefficients vector, and forming feature vectors by the optimal selection of wavelet coefficient vectors, which are later used for identification purposes.

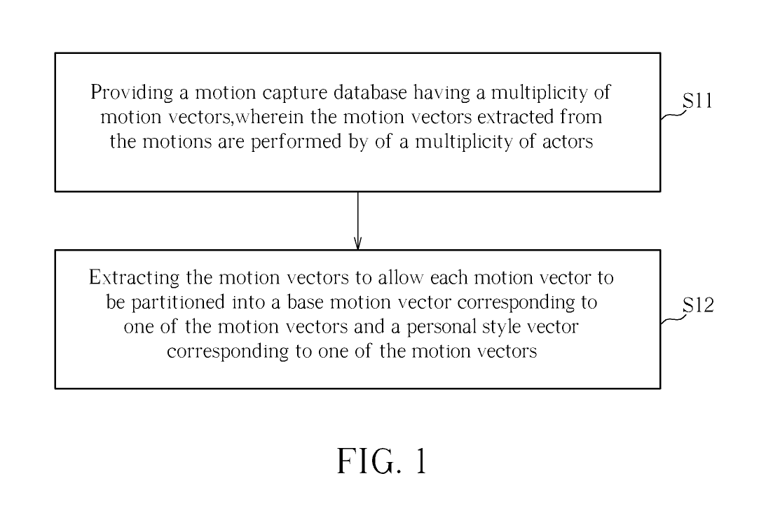

Referring to FIG. 1, a flow chart illustrates extracting personal styles from motion capture database according to an embodiment of the invention. The inventive method for automatically extracting personal styles from motion capture data may include the following steps. First of all, a motion capture database having a multiplicity of motion vectors is provided at step S11. The motion vectors are vectors extracted from the motions of a multiplicity of actors. Afterwards, the motion vectors are extracted at step S12 to allow each motion vector to be partitioned into a base motion vector corresponding to one of the motions and a personal style vector corresponding to one of the motions. The motion capture database contains different motions of different actors that are captured by tracking human movements of the multiple tracking points attached to joints through the use of a mechanical module, an electromagnetic module, or an optical module. The relative displacement or spin of each tracking point is recorded to gain the motion vector accordingly. In this embodiment, the captured motion data of each actor may be a motion vector of 76 dimensional spaces, although a different number of dimensional spaces may be used according to design considerations. In practical applications, the step S12 further includes the steps of transforming the motion vectors into multi-resolution wavelet coefficients, and giving an optimization parameter to partition the multi-resolution wavelet coefficients into a base motion vector and the personal style vector. For a first actor A, the relationship among the motion vector, the base motion vector, and the personal style vector can be denoted by the following equation:

M(A)=M(0)⊕X(A) (1)

where M (A) is the motion vector of the first actor A, M (0) is the base motion vector function, and X (A) is the personal style vector function specific to the first actor A. Through the addition operator ⊕, the base motion vector function and the personal style vector function can be added to gain the motion vector function. The base motion vector function M (0) is the smoothed version of the original movement indicative of the basic human motion, e.g. waving arms, walking, standing up or sitting down. When different actors perform the same motion, for example, waving their arms, the extracted base motion vectors may be smoothed to more closely approximate each to form the base motion. When the same actor acts different motions, the extracted personal style motion vectors are approximate to each other. Suppose the parameter n in the motion vector function Mₙ(A) is 1 . . . q, it indicates that the first actor acts q different motions. The extracted personal style vector function Xₘ(A), m=1 . . . q, indicative of the personal styles of the first actor A, can be retained in the database for later usage for motion synthesis and identification purposes.

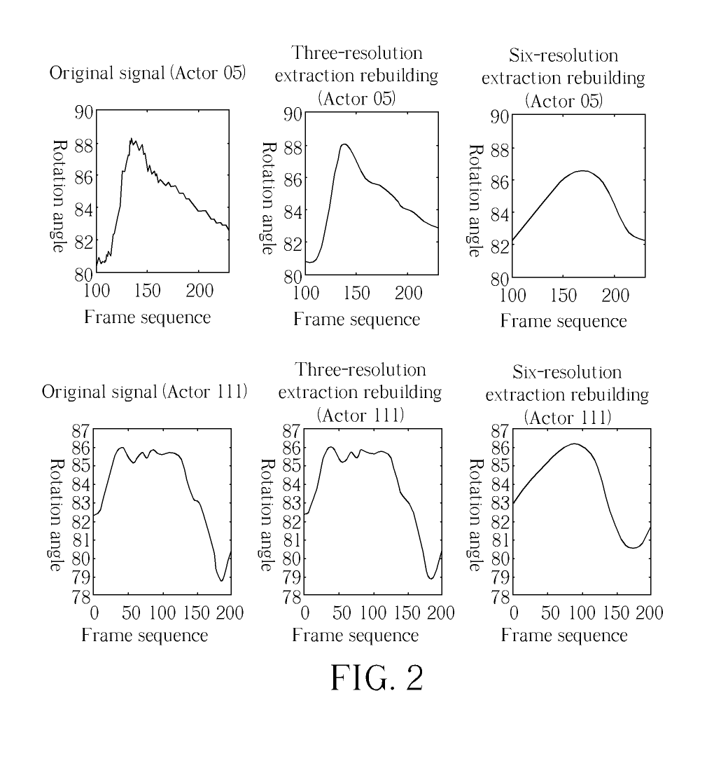

One way, inter alia, that the invention is capable of extracting a motion vector and partitioning the motion vector into a base motion vector and a personal style vector is based on the usage of multi-resolution wavelet coefficients for optimization. For example, FIG. 2 shows the characteristic chart depicting an example relationship of the rotation angle of the left hip joint when different actors are walking through the use of multi-resolution wavelet coefficient analysis. In this example, the actor 05 is a normal person and the actor 111 is a pregnant woman. Comparing the original signals of the actor 05 and the actor 111, it can be perceived that the differences between the original signals of the two actors are huge. After a three-resolution extraction rebuilding process is carried out, the differences between the extracted signals of the two actors are still huge. After a six-resolution extraction rebuilding process is carried out, the functional curve of the actor 05 and the functional curve of the actor 111 are very approximate to each other. Simply speaking, using multi-resolution wavelet analysis to extract a motion vector function can gain a series of wavelet coefficients.

Nonetheless, the invention can further partition the wavelet coefficients into approximation coefficients and detail coefficients. The function constituted by the approximation coefficients can roughly represent the approximate motion style of the original motion vector function, which is used to gain the base motion vector function by extraction. The function constituted by the detail coefficients can be taken as the difference of the original motion vector function minus the function constituted by the approximation coefficients, which is used to gain the personal style vector by extraction. By using multi-resolution wavelet analysis, the motion vector function can be separated into a base motion vector function and a personal style vector function.

However, the multi-resolution wavelet analysis can also be used to extract various wavelet coefficients of different resolutions under different resolutions. In order to efficiently extract the personal style vector function from the motion vector function in an independent manner, an optimal coefficient vector may be used in order to extract the personal style vector function. In the single human movement of walking, the activity of the joints may be different with each other. For example, the activity of the shoulder joints may be larger than the activity of the neck joints. Hence, the invention introduces an optimal coefficient vector to reflect the activity of the each joint and further control the optimization of the multi-resolution wavelet analysis.

Suppose the human body is represented in p channels, given a global error constraint Ec, an optimal set of detail coefficients {di} for the ith channel c can be found by the following equation:

E≦Ec (2)

where E is the total error introduced by removing these coefficients D={d i|i=1 . . . p} from all p channels. The optimization process must find the optimal distribution of the errors to all the channels of the joints under a global quality control. The length of di depends on the activities of the ith channel in the motions. More coefficients are removed from the less active channels. The global error constraint Ec controls how much a motion signal is filtered. The 12 bigger Ec is, the more coefficients can be removed and the coarser the reconstructed motion becomes.

The differences between the three actors of FIG. 2 are more distinguishable as we increase the value of Ec to some amount. However, when it reaches a certain high value, the number of coefficients for which removal is allowed for each actor is also high and the differences between them are then reduced. Therefore, the differences between these three actors are substantially indistinguishable. In practical applications, the invention can acquire a similar energy responsive to error constraints through this process regardless of the motion types. Suppose there are p channels in a motion, for a given global error constraint, a vector is obtained by the following equation:

$$X = ( e 1 , e 2 … ep ) \\ where \\ ek = \frac{1}{nk} {\sum }_{j - 1}^{nk} {\vert dkj \vert}^{2} \qquad ( 3 )$$

is the average energy of the kth channel and nk is the length of dk=(d k1, d k2, . . . , d knk), which is the selected wavelet coefficients for this channel.

Suppose we want to analyze q different Ecs, the feature vector for this motion can be obtained by the following equation:

X={xi|i=1 . . . q} (5)

This extracted feature records the energy changes of the joint signals with respect to different global error tolerances. It is based on the assumption that people's moving styles are preserved to some extent regardless of the types of motion and these special characteristics can be modeled by some selected wavelet coefficients.

After the practical application is completed, the Euclidean distances in p-dimensional space algorithm, the K-means clustering algorithm and/or the Bayes classification algorithms can be applied to the motion capture database to evaluate the performance. The evaluation results manifest the feasibility and the ability of group classification of the invention. Therefore, it is not intended to dwell upon herein. By using the inventive method for extracting personal styles from captured motions to process animation frames, the performance can be evaluated by grouping by group clustering and classification matrix. Also, even if the type of the motion is not stored in the database in advance, the motions of the actor can still be recognized by a learning module regardless of the type of the motions.

Suppose a first actor A performs a first motion M1 (A) and a second actor B performs a second motion M2 (B), we can extract the base motion vector M2 (0) to simulate the second motion M2 (A) of the first actor A by motion synthesis. In practical applications, given a global error allowance Ec, the corresponding personal style vector X can be extracted by using the disclosed method for extracting personal styles from captured motions. This vector records the energy distribution of the extracted wavelet coefficients. First the multi-resolution wavelet analysis is performed to extract:

M1(A)=M1(0)⊕X(A) (6)

M2(B)=M2(0)⊕X(B) (7)

Suppose xi (A) and xj (B) denote the energy distributions of the extracted coefficients from M1 (A) and M2 (B), given the global error constraints Ec,i and Ec,j, respectively. The following steps can then be performed: (1) Normalize xi (A) to [0, 1]; (2) Normalize xj (B) to [0, 1]; (3) Compute the square root of the ratio between normalized xi (A) and xj (B); and (4) Multiply the result to each extracted coefficient from M2 (B). These steps simply scale the extracted coefficients so that the energy distribution of the coefficient from M2 (B) matches the energy distribution of those obtained from M1 (A). This can manifest that the following equation (8) is correct.

M2(A)=M2(0)⊕X(A) (8)

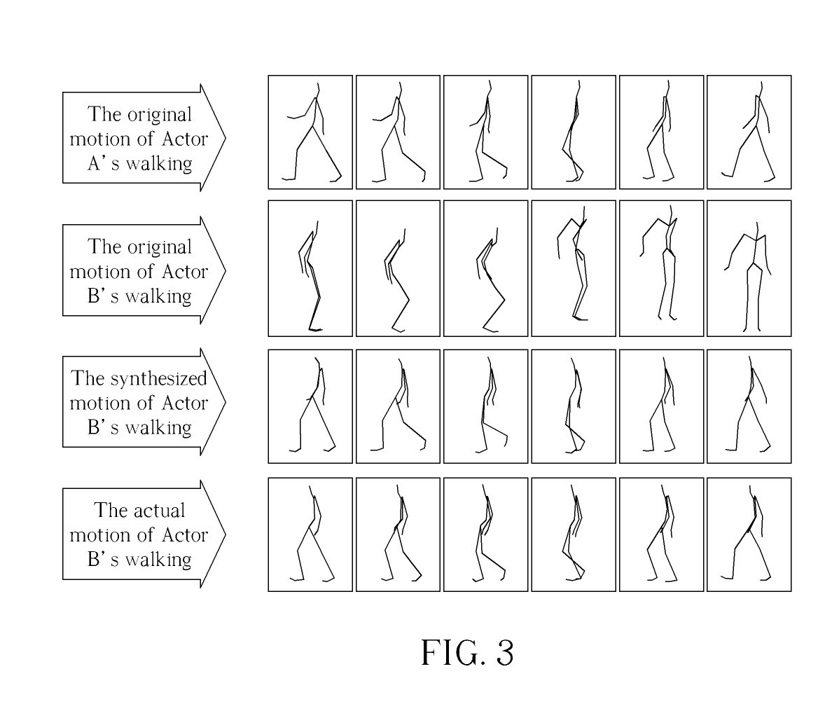

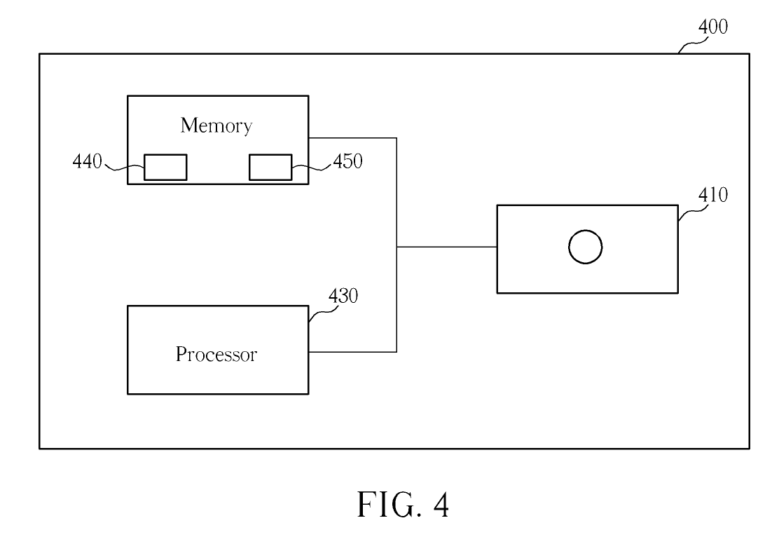

FIG. 3 is a diagrammatic view depicting the application wherein an embodiment of the invention is employed in motion synthesis. As illustrated in FIG. 3, the first row shows the original walking motion of the actor A, and the second row shows the original leaping motion of the actor B. With these two different motions by different actors as the inputs to the system, the personal style of the actor B extracted from the leaping motion of the actor B can be applied to the base walking motion extracted from the walking motion of the actor A. The resulting motion is shown in the 3rd row, which is a synthesized walking motion with the actor B's style. The motion in the fourth row is the actual walking motion of the actor B. Comparing the synthesized walking motion of FIG. 3 to the actual walking motion of FIG. 4, it can be seen that the synthesized motion of the actor B shown in FIG. 3 does indeed show similarities to the actual motions of actor B shown in FIG. 4.

Simply speaking, the invention provides a method for personal styles from captured motion data, which includes the steps of: first, providing a motion capture database having a multiplicity of motion vectors captured from a first motion performed by a first actor, a multiplicity of motion vectors captured from a second motion performed by the first actor, a multiplicity of motion vectors captured from a first motion performed by a second actor, and a multiplicity of motion vectors captured from a second motion performed by the second actor. Next, extracting the motion vectors to allow each motion vector to be partitioned into a base motion vector and a personal style vector, in which both of the motion vector of the first motion performed by the first actor and the motion vector of the first motion performed by the second actor can be extracted to produce the same first base motion vector, and both of the motion vector of 17 the second motion performed by the first actor and the motion vector of the second motion performed by the second actor can be extracted to produce the same second base motion vector. Both of the motion vector of the first motion performed by the first actor and the motion vector of the second motion performed by the first actor can be extracted to produce substantially the same first personal style vector, and both of the motion vector of the first motion performed by the second actor and the motion vector of the second motion performed by the second actor can be extracted to produce the substantially same second personal style vector.

In some embodiments, the extracting method can be applied to motion synthesis, which may include the steps of: providing a multiplicity of motion vectors captured from the third motion performed by the first actor; extracting the motion vectors of the third motion performed by the first actor to allow each motion vector to be partitioned into a third base motion vector and the first personal style vector; and synthesizing the third base motion vector and the second personal style vector to obtain the motion vector of the third motion performed by the second actor.

In some embodiments, the extracting method can be applied to identity recognition, which includes the steps of: providing a multiplicity of motion vectors captured from a first motion performed by an unknown actor; extracting the motion vectors to allow each motion vector to be partitioned into a first base motion vector and an unknown personal style vector; and comparing the unknown personal style vector with the first personal style vector and the second personal style vector; if the unknown personal style vector matches with the first personal style vector, the unknown actor is identified as the first actor; if the unknown personal style vector matches 18 with the second personal style vector, the unknown actor is identified as the second actor.

In some embodiments, the extracting method can be applied to group classification, which includes the steps of: providing a multiplicity of motion vectors captured from a first motion performed by a third actor; extracting the motion vectors to allow each motion vector to be partitioned into a first base motion vector and a third personal style vector; and comparing the third personal style vector with the first personal style vector and the second personal style vector; if the third personal style vector is similar to the first personal style vector, the third actor is determined to have close affinity with the first actor; if the third personal style vector is similar to the second personal style vector, the third actor is determined to have close affinity with the second actor.

Computer code enabling various embodiments of the disclosure can be placed on non-transitory computer readable medium. Such computer code which when executed by a processor may include separating a smoothed signal representing a base movement into wavelets, each wavelet having a corresponding coefficient to model a detail of the base movement, optimizing the smoothed signal by removing at least one coefficient such that a total error introduced by removal of the at least one coefficient is less than or equal to a predefined global error value, generating a feature vector identifying a personal style according to an energy level of the removed coefficients, generating a plurality of signals each corresponding to a channel corresponding to a same base movement of a plurality of actors, filtering the plurality of signals into a smoothed signal representing the base movement, and/or applying the feature vector to a selected base movement to generate a stylized movement.

A motion capture system 400 suitable for using disclosed methods is shown in FIG. 4. The motion capture system 400 may include at least one video source 410 providing data for a recorded motion, a processor 430 configured to generate a feature vector 440 comprising a difference between energies of respective coefficients indicating detail for wavelets of a smoothed wave corresponding to a stored base motion 450 and respective coefficients indicating detail for wavelets of the provided data for the recorded motion; and a memory 420 storing the motion vector 450 and the feature vector 440. The motion capture system 400 may have the processor 430 further configured to identify the actor used in the provided data for the recorded motion according to a comparison of the feature vector with a plurality of feature vectors stored in the memory and/or further configured to modify the feature vector so that energy distribution of the respective coefficients indicating detail for wavelets of the provided data for the recorded motion matches energy distribution of the coefficients indicating detail for wavelets of a smoothed wave corresponding to a stored base motion. In FIG. 4 a video camera 410 is shown as a possible video source, but the video source 410 is defined to also include, inter alia, a transitory or non-transitory video file.

In conclusion, the invention provides a method for automatically extracting personal styles from captured motion data. The inventive method employs the wavelet analysis to extract the captured motion vectors of different actors into wavelet coefficients, thereby forming a feature vector by optimization selection, which is later used for identification purposes or simulation of motion synthesis. Also, even if the type of the motion is not stored in the database in advance, the motions of the actor can still be recognized by a learning module regardless of the type of the motions. More advantageously, the invention can perform group classification to the captured motion vectors in the database for analysis.

While the present invention has been described in terms of what are presently considered to be the most practical and preferred embodiments, it is to be understood that the present invention need not be restricted to the disclosed 19 embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for generating stylized movement, the method comprising:
separating motion data in a database from a plurality of channels into wavelets, each wavelet having a corresponding coefficient to model a detail of a corresponding base movement;
extracting a number of coefficients such that a total error from the motion data introduced by extraction of the number of coefficients is less than or equal to a predefined global error value;
generating a feature vector representing a personal style according to an energy level of the extracted coefficients; and
applying the feature vector to a selected base movement to generate a stylized movement.

2. The method of claim 1 wherein a number of coefficients removed is determined according to an amount of activity in the corresponding channel and the predefined global error value.

3. The method of claim 1 further comprising modifying the extracted coefficients so that energy distribution among all channels matches the energy distribution of the extracted coefficients.

4. A method for extracting and identifying personal styles of motion, the method comprising:
generating a plurality of signals each corresponding to a channel corresponding to a same base movement of a plurality of actors;
smoothing a plurality of motion data from a channel corresponding to a same base movement of a plurality of actors into a smoothed representation of the base movement;
separating the smoothed representation of the base movement into wavelets, each wavelet having a corresponding coefficient to model a detail of the base movement;
extracting a number of coefficients such that a total error introduced by extraction of the number of coefficients is less than or equal to a predefined global error value; and
generating a feature vector representing a personal style according to an energy level of the extracted coefficients.

5. A non-transitory computer readable medium comprising:
computer code which when executed by a processor separates a smoothed signal representing a base movement into wavelets, each wavelet having a corresponding coefficient to model a detail of the base movement;
computer code which when executed by a processor optimizes the smoothed signal by removing at least one coefficient such that a total error introduced by removal of the at least one coefficient is less than or equal to a predefined global error value; and
computer code which when executed by a processor generates a feature vector representing a personal style according to an energy level of the removed at least one coefficients.

6. The non-transitory computer readable medium of claim 5 further comprising:
computer code which when executed by the processor generates a plurality of signals each corresponding to a channel corresponding to a same base movement of a plurality of actors; and
computer code which when executed by the processor filters the plurality of signals into the smoothed signal representing the base movement.

7. The non-transitory computer readable medium of claim 5 further comprising computer code which when executed by the processor applies the feature vector to a selected base movement different than the base movement to generate a stylized movement.

8. A motion recognition method, comprising the steps of:
providing a database having a multiplicity of feature vectors captured from a multiplicity of motions performed by a multiplicity of actors;
generating an unknown feature vector that is not in the database; and
comparing the unknown feature to the feature vectors extracted from the database, thereby recognizing an actor of the unknown feature vector or recognizing a motion of the unknown motion vector.

9. A motion capture system comprising:
at least one video source providing data for a recorded motion;
a processor configured to generate a feature vector comprising a difference between energies of respective coefficients indicating detail for wavelets of a smoothed wave corresponding to a stored base motion and respective coefficients indicating detail for wavelets of the provided data for the recorded motion; and
a memory storing the motion vector and the feature vector.

10. The motion capture system of claim 9 wherein the processor is further configured to identify the actor used in the provided data for the recorded motion according to a comparison of the feature vector with a plurality of feature vectors stored in the memory.

11. The motion capture system of claim 9 wherein the processor is further configured to modify the feature vector so that energy distribution of the respective coefficients indicating detail for wavelets of the provided data for the recorded motion matches energy distribution of the coefficients indicating detail for wavelets of a smoothed wave corresponding to a stored base motion.

12. A method for identifying personal styles by way of motion capture, the method comprising:
separating a smoothed signal representing a reference base movement into wavelets, each wavelet having a corresponding coefficient to model a detail of the base movement;
optimizing the smoothed signal by removing at least one coefficient such that a total error introduced by removal of the at least one coefficient is less than or equal to a predefined global error value;
determining the wavelet coefficients of a captured movement; and
generating a feature vector identifying a personal style according to an energy level of wavelet coefficients in the captured movement corresponding to the removed at least one coefficients in the base motion.

13. The method of claim 12 further comprising:
generating a plurality of signals each corresponding to a channel corresponding to a same base movement of a plurality of actors; and
filtering the plurality of signals into the smoothed signal representing the reference base movement.

14. The method of claim 13 further comprising applying the feature vector to a selected base movement to generate a stylized movement having the identified personal style.

15. A method for synthesizing personal style motions, comprising the steps of:
providing a motion capture database having a multiplicity of motion vectors captured from a multiplicity of motions performed by a multiplicity of actors;
extracting the motion vectors to allow each motion vector to be partitioned into a base motion vector corresponding to one of the motions and a personal style vector corresponding to one of the motions; and
synthesizing the base motion vector and the personal style vector to obtain a specific motion vector that is not captured in the motion capture database.

16. A method for synthesizing person style motions using motion capture, the method comprising:
capturing a first motion of a first actor;
capturing a second motion different from the first motion by a second actor different than the first actor;
generating a set of wavelet coefficients representing details of the first and second motions for each of the first and second motions;
dividing the set of wavelet coefficients for the first motion into subsets, with a first subset representing the base first motion and a second subset representing personal style of the first actor;
dividing the set of wavelet coefficients for the second motion into subsets, with a third subset representing the base second motion and a fourth subset representing personal style of the second actor; and
combining the first subset with the fourth subset to generate a new motion having the first motion performed having the personal style of the second actor.

17. A method for extracting personal styles from captured motion data, the method comprising:
providing a motion capture database having a multiplicity of motion vectors captured from a multiplicity of motions performed by a multiplicity of actors; and
extracting the motion vectors to allow each motion vector to be partitioned into a base motion vector corresponding to one of the motions and a personal style vector corresponding to one of the motions.

18. The method according to claim 17 further comprising:
transforming the motion vectors into multi-resolution wavelet coefficients; and
giving an optimization parameter to partition the multi-resolution wavelet coefficients into a base motion vector and a personal style vector.

19. The method according to claim 18 wherein the optimization parameter is a global error constraint, and wherein a total error is derived by subtracting the personal style vector from the motion vector, and wherein the total error is lower than or equal to the global error constraint.

20. The method according to claim 18 wherein the optimization parameter further includes an energy distribution vector for representing the quantity of the multi-resolution wavelet coefficients.

21. The method according to claim 17 wherein motion vectors captured from the same motions performed by the different actors are extracted to produce the same base motion vector.

22. The method according to claim 17 wherein motion vectors captured from different motions performed by the same actor are extracted to produce the same personal style vector.

23. The method according to claim 17 wherein each motion vector in the motion capture database is a displacement vector or rotation vector of a multiplicity of joints on the human body skeleton.

24. The method according to claim 17 further comprising the steps of:
extracting an unknown motion vector that is not captured in the motion capture database to obtain a corresponding base motion vector and a corresponding personal style vector; and
comparing the corresponding base motion vector and the corresponding personal style vector with a base motion vector and a personal style vector extracted from the motion capture database, thereby identifying an actor of the unknown motion vector or identifying a motion of the unknown motion vector.

25. The method according to claim 17 further comprising classifying personal style vectors extracted from the motion capture database, thereby grouping motion affinities of the multiplicity of actors.
